(19) United States
(12) Patent Application Publication
(10) Pub. No.: US 2016/0362048 A1
(43) Pub. Date: Dec. 15, 2016

(54) SELF-MONITORING OF VEHICLES IN A CONVOY

(71) Applicant: Aware 360 Ltd., Calgary (CA)

(72) Inventors: Steven Gregory MATTHEWS, Calgary (CA); James Frederick McLELLAN, Calgary (CA)

(73) Assignee: Aware 360 Ltd., Calgary (CA)

(21) Appl. No.: 15/172,818

(22) Filed: Jun. 3, 2016

Related U.S. Application Data
(60) Provisional application No. 62/172,873, filed on Jun. 9, 2015.

(51) Int. Cl. B60Q 9/00; G01C 21/34; G08G 1/01; G01S 19/42; G08G 1/052; G08G 1/00

(52) U.S. Cl. CPC B60Q 9/00; G08G 1/052; G08G 1/22; G08G 1/0145; G01S 19/42; G01C 21/34

(57) ABSTRACT

A method for maintaining vehicle speeds and distances between vehicles travelling in a convoy along a convoy route. The method includes determining locations and speeds of the vehicles; transmitting the locations and speeds of the vehicles by radio transmission to any of the other vehicles of the convoy within radio communication range; providing an automated speed alert to a driver of an individual vehicle of the vehicles if the speed of the individual vehicle violates a speed limit for a segment of the convoy route; and providing an automated distance alert to the driver of the individual vehicle if the individual vehicle violates a distance limit for a segment of the convoy route with respect to leading and/or trailing vehicles of the fleet of vehicles.

### CROSS REFERENCE TO RELATED APPLICATIONS

This application claims priority from U.S. Provisional Application Ser. No. 62/172,873 filed Jun. 9, 2015, which is incorporated herein by reference in its entirety.

### FIELD OF THE INVENTION

The invention relates to the field of vehicle control and provides methods and systems for this purpose.

### BACKGROUND OF THE INVENTION

Efforts to transport supplies to remote communities or industrial sites at remote locations have a number of logistical problems. One such problem is that the roadways used for access to such locations are not provided with safety features common to major roadways servicing populated areas due to prohibitive costs associated therewith. In addition, remote roadways tend to traverse a number of hazards.

One such example of a remote roadway is an ice road. Ice roads are frozen pathways on the surface of bays, rivers, lakes, or seas in polar regions. They link dry land, frozen waterways, portages and winter roads, and are usually remade each winter. Ice roads provide a temporary surface for transport of supplies and equipment to areas with no permanent road access. Ice roads are in common use during the winter in isolated regions of northern Canada, Alaska, northern Michigan, northern Scandinavia, Estonia, Northeast China and Russia. The use of ice roads reduces the cost of materials that otherwise would be shipped as expensive air freight, and they allow movement of large or heavy objects for which air freight is impractical.

Ice roads differ from winter roads in that they are built primarily across frozen waterways. However, an ice road may in some cases be part of a longer winter road whose path traverses both water and land. As such, the transport of goods and supplies across ice roads will involve a number of topographical hazards.

Transport of goods and supplies to remote locations will often be conducted using a convoy of vehicles originating from a centralized location. For example, a number of suppliers will ship supplies destined for a remote mining community to a staging area where a specialty transport firm experienced in the use of ice roads will transfer the goods to its fleet of vehicles and coordinate a mass shipment using these vehicles. It is desirable to ensure the safety of the drivers of the vehicles and their cargoes as well as minimizing damage to the ice road itself.

A number of convoy coordination systems and methods are known. For example, U.S. Patent Publication No. 2009/0079839 to Fischer et al. describes a system and method for controlling a convoy of vehicles. The convoy of vehicles includes a leader vehicle in communication with a plurality of autonomous follower vehicles. The system and method is directed primarily to convoys of military vehicles. The leader vehicle is configured to receive a first autonomous follower vehicle data and compare the first autonomous follower vehicle data to at least one of a leader vehicle data, a second autonomous follower vehicle data and/or a threshold value relating to a vehicle performance characteristic, which may include vehicle speed. This document describes GPS positioning of vehicles, a path planning module, an information database, a collection of position information, monitoring rates of speed and the use of algorithms to influence issuance of commands.

U.S. Patent Publication No. 2010/0256835 to Mudalige describes a method for controlling speed of a vehicle based upon control messages received through a communications device within the vehicle. The control messages include a speed profile including a current speed command representing instantaneous desired speed of the vehicle and future speed commands representing a predetermined controlled vehicle stop through a speed profile period, detecting anomalous communications of the control messages, and controlling the speed of the vehicle during anomalous communications using the future speed commands. The method primarily relates to autonomous vehicles in platoon situations where a leader vehicle controls a group of other vehicles. A number of processes for fixing the locations of moving vehicles are described which use GPS signals, cameras, radar and radio tower transmissions. A method for controlling the relative location of a vehicle with respect to other vehicles using ultrasonic ranging or radar signals is described. Short range radio communication signals are used to achieve communication between vehicles. Exemplary minimum spacing between vehicles is described.

U.S. Patent Publication No. 2013/0050244 to Kim describes a location tracking system developed primarily for tracking individuals in situations such as verifying locations of children during outdoor group activities. The system provides a warning sound when an individual departs from specified limits.

U.S. Patent Publication No. 2014/0309836 to Ollis describes a computer-implemented method for providing position estimations in an autonomous multi-vehicle convoy. The method steps include initializing a convoy state, selecting a next sensor reading; predicting a convoy state, updating the convoy state, and broadcasting the convoy state. This document describes the use of GPS, processing of GPS data and estimating distances between vehicles with a safety margin.

U.S. Pat. No. 7,831,345 to Heino and Vauramo describes a transport system for driving mine vehicles in a mine. A plurality of mine vehicles is arranged in succession and driven in convoy between working areas. A master vehicle in the convoy is driven manually, and slave vehicles follow the master, provided with no mechanical connection. In the working areas, the convoy is disassembled, since single vehicles are each driven separately. When assigned tasks in the working areas have been completed, the vehicles are reassembled into a convoy so as to be driven to a next working area. Navigational systems such as laser scanners and gyroscopes are used. Electronic maps of the mine features are included in the control unit of the transport system.

U.S. Pat. Nos. 8,352,111 and 8,352,112 to Mudalige describe methods for controlling a plurality of vehicles to operate the plurality of vehicles in a platoon and methods for determining navigational commands for the host vehicle based upon the trajectory of the host vehicle and the trajectory of each of the target vehicles, and operating the host vehicle based upon the navigational commands.

U.S. Pat. No. 8,855,835 to Kumabe describes a convoy travel apparatus in a subject vehicle of a convoy transmits a convoy travel information, which includes the maximum allowable number and the currently-included number of vehicles in the convoy. The apparatus determines whether the subject vehicle is blocking a signal from a leader vehicle of the convoy in which the subject vehicle is traveling as a follower vehicle, where the signal being blocked by the subject vehicle may not reach a position of a rearmost vehicle in the convoy. When the subject vehicle is determined to be blocking the signal, the subject vehicle transmits the convoy travel information indicating that the subject vehicle as a leader vehicle (i.e., a representative leader vehicle) of the convoy, thereby enabling a newly-joining vehicle to receive the convoy travel information transmitted from the follower vehicle in the convoy.

In view of the foregoing, there continues to be a need for improvements in controlling vehicles in a convoy to ensure safety and efficiency.

### SUMMARY OF THE INVENTION

One aspect of the present invention is a method for maintaining vehicle speeds and distances between vehicles travelling in a convoy along a convoy route, the method comprising the steps of: a) determining locations and speeds of the vehicles; b) transmitting the locations and speeds of the vehicles by radio transmission to any of the other vehicles of the convoy within radio communication range; c) providing an automated speed alert to a driver of an individual vehicle of the vehicles if the speed of the individual vehicle violates a speed limit for a segment of the convoy route; and d) providing an automated distance alert to the driver of the individual vehicle if the individual vehicle violates a distance limit for a segment of the convoy route with respect to leading and/or trailing vehicles of the fleet of vehicles.

In certain embodiments, the radio communication is short range radio and the radio communication range is about 1 km.

In certain embodiments, the locations and direction of travel of the vehicles are determined using a satellite positioning system.

In certain embodiments, the speeds of the vehicles are determined using a satellite positioning system or using speed gauges of the vehicles.

In certain embodiments, the speed limit is contained in a database of speed limits for segments of the convoy route and the vehicle's speed is automatically compared with the database of speed limits to determine compliance or violation of a speed limit for the segment of the convoy route.

In certain embodiments, the distances of the leading and/or trailing vehicles from the vehicle are automatically compared with the database of distance limits to determine compliance or violation of a distance limit for the segment of the convoy route.

In certain embodiments, the automated speed alert is an audible signal or a visible signal or both.

In certain embodiments, the automated distance alert is an audible signal or a visible signal or both.

Another aspect of the present invention is a device for use in an individual vehicle of a fleet of vehicles travelling along a convoy route, the device for maintaining vehicle speeds and distances between vehicles, the device comprising: a) a satellite positioning receiver for determining the location of the individual vehicle; b) a radio modem for transmitting the location and speed of the individual vehicle to other vehicles of the fleet of vehicles within radio transmission range and for receiving the locations and speeds of the other vehicles within radio transmission range; c) one or more databases including: i) map data associated with the convoy route; ii) speed limits for defined segments of the convoy route: and iii) vehicle distance limits for the defined segments of the convoy route; d) firmware configured to compare the locations and speeds of the individual vehicle and the other vehicles within radio transmission range with the speed limits and the vehicle distance limits in the databases and for providing audible and/or visible alerts if the speed limits and/or the distance limits are violated.

In certain embodiments, the device further comprises one or more additional modems for one or more corresponding communication modes selected from the group consisting of Wi-Fi network, cellular network and satellite network, the one or more communication modes for communicating with a central monitoring station.

In certain embodiments, the satellite positioning receiver is configured to receive positioning data from a GNSS system selected from a GPS system, a GLONASS system, a BeiDou system, and a Galileo system or an integrated GNSS system of any combination thereof.

In certain embodiments, the radio modem is configured for ZigBee™ radio communication.

In certain embodiments, the databases are configured to be updated from the central monitoring station.

In certain embodiments, the speed of the individual vehicle is determined by an on-board vehicle computer or by a calculation performed by the satellite positioning receiver.

Another aspect of the present invention is a method for maintaining vehicle speeds and distances between vehicles travelling in a convoy along a convoy route, the method comprising: a) determining locations and speeds of the vehicles; b) transmitting the locations and speeds of the vehicles by radio transmission to any of the other vehicles of the convoy within radio communication range; c) providing an automated speed alert to a driver of an individual vehicle of the vehicles if the speed of the individual vehicle violates a speed limit for a segment of the convoy route; d) providing an automated distance alert to the driver of the individual vehicle if the individual vehicle violates a distance limit for a segment of the convoy route with respect to leading and/or trailing vehicles of the fleet of vehicles; and e) updating the speed limit and/or the distance limit if the convoy route is subjected to changing weather and/or road surface conditions.

In certain embodiments, step e) is performed remotely by a central monitoring station in communication with the vehicles.

In certain embodiments, the central monitoring station communicates with the vehicles by one or more communication modes selected from the group consisting of a Wi-Fi network, a cellular network and a satellite network.

In certain embodiments, the method further comprises the step of receiving an automated weather report at the central monitoring station and automatically performing step e) on the basis of the automated weather report.

In certain embodiments, the radio communication is short range radio and the radio communication range is about 1 km.

In certain embodiments, the locations and direction of travel of the vehicles are determined using a satellite positioning system.

In certain embodiments, the speeds of the vehicles are determined using a satellite positioning system or using speed gauges of the vehicles.

In certain embodiments, the speed limit is contained in a database of speed limits for segments of the convoy route and the vehicle's speed is automatically compared with the database of speed limits to determine compliance or violation of a speed limit for the segment of the convoy route.

In certain embodiments, the distances of the leading and/or trailing vehicles from the vehicle are automatically compared with the database of distance limits to determine compliance or violation of a distance limit for the segment of the convoy route.

In certain embodiments, the automated speed alert is an audible signal or a visible signal or both.

In certain embodiments, the automated distance alert is an audible signal or a visible signal or both.

### BRIEF DESCRIPTION OF THE DRAWINGS

Various objects, features and advantages of the invention will be apparent from the following description of particular embodiments of the invention, as illustrated in the accompanying drawings. Emphasis is placed upon illustrating the principles of various embodiments of the invention.

FIG. 1 is a schematic diagram indicating how an ice road convoy route includes segments with different speed limits and shows selected vehicles from two convoys moving in opposite directions along the ice road route.

FIG. 2 is a schematic diagram indicating how a convoy route is divided into segments with speed and distance limits associated therewith, and also demonstrates how alerts are triggered by vehicles exceeding the speed and distance limits.

FIG. 3 is a flow diagram indicating the operation of the network device 10 carried in each vehicle of the convoy.

### DETAILED DESCRIPTION OF THE INVENTION

### Rationale

Transport fleet vehicles have been in use for many years and radio communications among the drivers of such vehicles have been used to provide alerts relating to various hazards that may be encountered along the common route.

As positioning systems and geomatics databases are becoming more accurate and sophisticated and as processing power and storage capacity has become more affordable, the inventors have recognized it is now possible to provide each vehicle in a convoy of fleet vehicles traversing hazardous terrain with a geomatics system overlaid with recommended speed limits and spacing limits between vehicles for sections of a defined route, thereby providing drivers with information that will inform them of potential safety and maintenance issues along the route. It has also been recognized by the inventors that such powerful information may be complemented enhanced by a number of additional features that can be incorporated into an automated audio and/or visual messaging unit so that the driver can concentrate on driving and avoid examining maps and related information displayed on an electronic device because it is well known that such distractions can lead to accidents, particularly in potentially hazardous terrain. The resulting invention, described in detail below, is provided to take advantage of technological developments in positioning, geomatics and processing power while ensuring the safety of fleet drivers operating in relatively close proximity to each other while traversing potentially hazardous terrain or roadways.

As noted above, ice roads are one example of potentially hazardous terrain traversed by convoys carrying supplies and equipment. One notable example of a route that includes ice roads is the Tibbitt-to-Contwoyto Winter Road which is operated as a joint venture by a group of multi-national mining companies in order to provide supplies and equipment to a number of remote mining operations. This road is approximately 570 km long and begins 70 km north of the city of Yellowknife in the Northwest Territories of Canada. A total of 85% of the distance is covered by crossing frozen lakes and the remaining land sections are known as “portages” (by analogy with the same term used to describe the activity involving carrying a canoe over land between lakes).

A number of different speed limits are imposed along the route and it is critical that the drivers of the transports adhere to these speed limits. For example, when a heavy transport vehicle traverses an ice road, a depression forms in the ice and this creates a wave in the water beneath the ice. If the vehicle is nearing a transition point where the ice meets land, the underlying wave can cause buckling and breakage of the ice when it reaches the land at the transition point. In addition to causing a significant safety hazard for drivers, it is time consuming and expensive to repair such damage. Therefore, speed limits are lower near these transition zones. Furthermore, maintenance of ice roads requires flooding with water to increase the thickness of the ice. Recently flooded zones on lakes are more susceptible to damage caused by transport vehicles and therefore roadway segments that include such flood zones will also have reduced speed limits.

As noted above, when a transport vehicle travels on the ice, a depression forms in the ice. For this reason, it is important that transport vehicles not travel too close to each other in order to minimize the extent of the depression and the likelihood of ice damage and the possibility of the transport vehicles breaking through the ice. It is therefore desirable to set a minimum allowable distance between the vehicles. On the Tibbitt-to-Contwoyto Winter Road, a typical minimum allowable distance between vehicles is 500 m. However, certain exceptions are applicable.

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

While the ensuing description is focused on applications of the system for transport of goods and equipment to remote locations across potentially hazardous terrain, the skilled person will recognize that other applications of the system are possible, such as transport of troops and armaments in a military convoy or column, for example.

### Definitions

As used herein, the term “geomatics” is the discipline of gathering, storing, processing, and delivering geographic information, or spatially referenced information. The term is synonymous with geospatial technology, geomatics engineering, and geomatic engineering. As used herein, the related term “geomatics database” refers to a database containing any information pertaining to geomatics. Examples may include, but are not limited to, topographical information, road surface conditions, time and location-specific weather conditions and the like.

As used herein, the term “firmware” refers to the combination of a hardware device, e.g. an integrated circuit, and computer instructions and data that reside as read only software on that device. Typical examples of devices containing firmware are embedded systems (such as traffic lights, consumer appliances, and digital watches), computers, computer peripherals, mobile phones, and digital cameras. The firmware contained in these devices provides the control program for the device.

Firmware is held in non-volatile memory devices such as ROM, EPROM, or flash memory. Changing the firmware of a device may rarely or never be done during its economic lifetime; some firmware memory devices are permanently installed and cannot be changed after manufacture. Common reasons for updating firmware include fixing bugs or adding features to the device. This may require ROM integrated circuits to be physically replaced, or flash memory to be reprogrammed through a special procedure. Firmware such as the ROM BIOS of a personal computer may contain only elementary basic functions of a device and may only provide services to higher-level software. Firmware such as the program of an embedded system may be the only program that will run on the system and provide all of its functions.

As used herein, the term “convoy” refers to two or more vehicles traveling together.

### System Functionality

In one aspect of the present invention there is provided a network for self-monitoring of vehicles in a convoy. The system provides audible and/or simplified visual cues to the driver of each vehicle in the convoy with information regarding speeds and locations of leading and/or trailing vehicles to maintain the safety of each driver.

The system includes a network device carried in each vehicle of the convoy. The device includes a means for positioning the vehicle, a means for accessing the locations of one or more other vehicles of the convoy, a geomatics database containing information approximating the geometry of the road, which is required to match the position of the vehicle to the road geometry to obtain the speed limit for that section of road, a custom database which includes defined speed limits and vehicle spacing requirements (distance limits) for defined segments of the route as defined in the geomatics database, and firmware for processing locations and speeds of vehicles and comparing the locations and speeds with the defined speed limits and vehicle spacing requirements of the custom database. The firmware is provided with the capability to produce an audible or visible signal, or both, when a defined speed limit or spacing requirement is violated. For example, an audible signal or alert may be a coded series of beeps or a voice alert such as “increase speed—trailing vehicle is approaching.” Advantageously, the signals are relatively simple to avoid confusing and distracting the driver of the vehicle carrying the device.

In certain embodiments, each vehicle of the convoy carries the same communication device for the self-monitoring method. As such, there is no “master” vehicle which directs the convoy. Each vehicle of the convoy receives messages from the device according to data collected from that vehicle and from leading and trailing vehicles and uses this data to issue alert messages to the driver of each vehicle according to the parameters programmed in the custom database of the vehicle.

### Positioning Means

The network includes a receiver of a global navigation satellite system (GNSS). In certain embodiments, the GNSS is based on satellites of the United States NAVSTAR global positioning system (GPS) or by satellites in the Russian GLONASS system, or by an integrative combination of the two systems provided as known and implemented in the art. In other embodiments, positioning receivers compatible with other GNSSs will be used which are yet to be fully deployed, such as, for example, the Chinese BeiDou navigation satellite system and the European Union's Galileo satellite navigation system. It is known that a GNSS receiver also has the capability to provide speed data because time and location are estimated at any one location and point in time. Thus, in certain embodiments, vehicle speed data is calculated by the satellite positioning system and is used as the basis for determining if speed limits are violated. In alternative embodiments, the vehicle speed data is recorded directly by vehicle sensors and transmitted via a CAN bus data communication link as described hereinbelow. The positioning means may be provided as an integral part of the device or as a peripheral component in data communication with the device. The direction of travel is information also captured by the GNSS receiver. In certain embodiments, direction of travel (also known as “heading” or “course over ground (COG) is used as the basis for speed limits in segments of the route. For example, if the convoy is travelling on an ice road where loaded vehicles always travel in one direction and empty vehicles travel in the opposite direction, the heading of the vehicle, which is captured by the GNSS receiver, will indicate to the network the direction of travel on the roadway and speed limits will be linked accordingly.

### Vehicle Sensor Data Integration

Most modern vehicles are equipped with on-board diagnostics (OBD) systems based on message-based protocols, such as CAN bus. Such systems allow microcontrollers and devices to communicate with each other. Such systems may be linked to the network devices in the method and system of the present invention. In certain embodiments, a major system failure in a leading vehicle may be communicated immediately to a trailing vehicle to alert the driver of the trailing vehicle so that appropriate action may be taken in anticipation of system problems of the leading vehicle.

### Communication of Vehicle Location

The system for self-monitoring of vehicles includes a means for providing each vehicle in the convoy with locations of other vehicles in the convoy under certain circumstances. The skilled person will recognize that for most non-military applications of the network, the safety of the driver of any one vehicle is not dependent on constant reception of the locations of all of the other vehicles in the convoy, but is dependent on receipt of the location of a leading and/or a trailing vehicle because of the potential for collisions and/or the potential for causing damage to the surface of the roadway. When the system is used on an ice road, a situation where two adjacent vehicles in a convoy travel too close together, the likelihood of breaking through the ice increases significantly. Thus, the positioning information may be provided in a convenient and cost-effective manner by a short-range radio communication mode suitable for integration with the firmware of the device.

ZigBee™ is an appropriate short range radio transmission mode which is suitable for integration with the system described herein. ZigBee™ is a specification for a suite of high-level communication protocols used to create personal area networks built from small, low-power digital radios. ZigBee™ is based on an IEEE 802.15.4 standard. Though its low power consumption limits transmission distances to about 1 km, depending on power output and environmental characteristics, ZigBee™ devices can transmit data over long distances by passing data through a mesh network of intermediate devices to reach more distant ones. ZigBee™ is typically used in low data rate applications that require long battery life and secure networking (ZigBee networks are secured by 128 bit symmetric encryption keys.) ZigBee™ is best suited for intermittent data transmissions from a sensor or input device. Applications include wireless light switches, electrical meters with in-home-displays, traffic management systems, and other consumer and industrial equipment that requires short-range low-rate wireless data transfer. The technology defined by the ZigBee™ specification provides the range required for the systems and methods described herein. ZigBee™ operates in the industrial, scientific and medical (ISM) radio bands: 2.4 GHz in most jurisdictions worldwide; 784 MHz in China, 868 MHz in Europe and 915 MHz in the USA and Australia. Data rates vary from 20 kbit/s (868 MHz band) to 250 kbit/s (2.4 GHz band).

In embodiments where ZigBee™ is used as the short-range radio communication mode, a leading vehicle will obtain location information for trailing vehicles (as defined by their individual satellite positioning receivers) only if they are within the ZigBee™ range of approximately 1 km. The locations of additional trailing vehicles may be transmitted to the leading vehicle as well, provided they form part of a ZigBee™ mesh network.

### Communication with the Central Monitoring Station—Reports and Database Updates

Certain embodiments of the network system include two way communications between the device and the central monitoring station. In one such example, the central monitoring station communicates with each network device of each vehicle and transmits an update to the custom database of the network device whenever new hazards are discovered which will impact the effectiveness of the speed limits and spacing requirements. For example, if a portion of a given roadway segment has become damaged, it would be beneficial to lower the speed limit for that segment. Another possible solution would be to sub-divide the segment into one sub-segment retaining the original speed limit and another sub-segment containing the damaged portion which has a reduced speed limit.

Another example of updating the customizable database is the provision of defined speed limit reductions for all roadway segments experiencing or forecast to experience adverse weather conditions. In one example, the driver of a lead vehicle in a convoy on an ice road encounters a snow squall. Recognizing that the squall represents a hazard to trailing vehicles, the driver communicates directly with the central monitoring station via satellite network communication to inform the central monitoring station of the squall. The operator of the central monitoring station then performs a database update to reduce the higher speed limits of each of the roadway segments in the vicinity of the lake that the convoy is traveling on and transmits this update to the custom database of the network device of each vehicle in the convoy. An example of such a database update provided according to weather conditions is shown in Tables 1A and 1B where speed and distance limits are adjusted according to visibility conditions over a series of defined roadway segments. It is seen that the speed limit of 10 km/h does not change, but all higher speed limits are reduced to 20 km/h. Additionally, the minimum spacing is changed to 600 m wherever the speed limit is reduced to 20 km/h. The skilled person will recognize that the poor visibility conditions of Table 1B may be reverted to the conditions of Table 1A if the squall subsides and one of the drivers notifies the central monitoring station, which prompts reversion to the original conditions. In certain embodiments, the network device may be programmed to provide an alert to the driver that a database update has been performed and also notify the driver of the updated speed and distance limits for each segment as the vehicle enters each segment. The skilled person will recognize that such a feature may be sufficiently reliable to allow the operator of an ice road to dispense with placement of physical signs along the roadway to inform drivers of distance and speed limits.

TABLE 1A
Ice Road Speed and Distance Limits for Loaded
Transports - Good to Fair Visibility

| | Distance | | Speed | Min/Max | |
|---|---|---|---|---|---|
| Seg- | Markers | | Limit | Distance | Direc- |
| ment | (km) | Features/Conditions | (km/h) | (m) | tion |
| 25 | 302.5-307.0 | Lake | 25 | 500/1000 | North |
| 26 | 307.0-308.4 | Lake - Flood Zone | 10 | 600/1000 | North |
| 27 | 308.4-317.8 | Lake | 25 | 500/1000 | North |
| 28 | 317.8-318.0 | Portage Approach | 10 | 600/1000 | North |
| 29 | 318.0-331.3 | Portage (Land) | 30 | 500/1000 | North |
| 30 | 331.3-331.5 | Portage On/Off | 10 | 600/1000 | North |
| | | Zone | | | |
| 31 | 331.5-355.3 | Lake | 25 | 500/1000 | North |

TABLE 1B
Speed and Distance Limits for Loaded Transports - Poor Visibility

| | Distance | | Speed | Min/Max | |
|---|---|---|---|---|---|
| Seg- | Markers | | Limit | Distance | Direc- |
| ment | (km) | Features/Conditions | (km/h) | (m) | tion |
| 25 | 302.5-307.0 | Lake | 20 | 600/1000 | North |
| 26 | 307.0-308.4 | Lake - Flood Zone | 10 | 600/1000 | North |
| 27 | 308.4-317.8 | Lake | 20 | 600/1000 | North |
| 28 | 317.8-318.0 | Portage On/Off | 10 | 600/1000 | North |
| | | Zone | | | |
| 29 | 318.0-331.3 | Portage (Land) | 20 | 600/1000 | North |
| 30 | 331.3-331.5 | Portage Exit | 10 | 600/1000 | North |
| 31 | 336.0-355.3 | Lake | 20 | 600/1000 | North |

Another example of a weather-related update may be provided automatically by linkage of the central monitoring station with weather stations or in the vicinity of the convoy route. Receipt of an automated report of adverse weather to the central monitoring station will trigger an automatic database update to reduce the speed limits of all roadway segments in the vicinity of the weather station that provided the automated report.

Speed and spacing limits may also be customized according to the characteristics of individual vehicles. For example, if one vehicle is carrying a wide load, or an extra heavy load, pre-programmed speed limits may not be appropriate for that vehicle. In such a case, when the vehicle is being prepared for the trip and its characteristics (for example, width, length or weight) have been identified, an operator at the central monitoring station can then change the custom database to automatically issue alert messages to the driver of that vehicle when revised speed or distance limits are being exceeded by the vehicle or a leading or trailing vehicle with respect to the vehicle.

Additionally, the geomatics database can be updated. The geomatics database includes an integrated map that is stored within the devices of the vehicles of the convoy. The integrated map can be updated in a mechanism whereby only necessary changes geomatics database are synchronized with the master map server thus reducing data bandwidth costs. Algorithms to further reduce update map data transmitted are implemented by facilitating dynamic popularity and/or geographic area selection minimization rules. Rules are programmed to govern allowable synchronization communication conduits Wi-Fi vs cellular network vs satellite network and acceptable time windowing for transmission are used to restrict synchronization of the device maps database with the main map server at the central monitoring station and thus allow the control of the map synchronization update data transmission costs. Such an update could be performed to load a particular map into the geomatics database of each device of each vehicle in the convoy, for example via a WiFi network at a staging area before the vehicles of the convoy depart for their destination.

### EXAMPLES

### Example 1

### Self-Monitoring of Transport Vehicles on an Ice Road Route

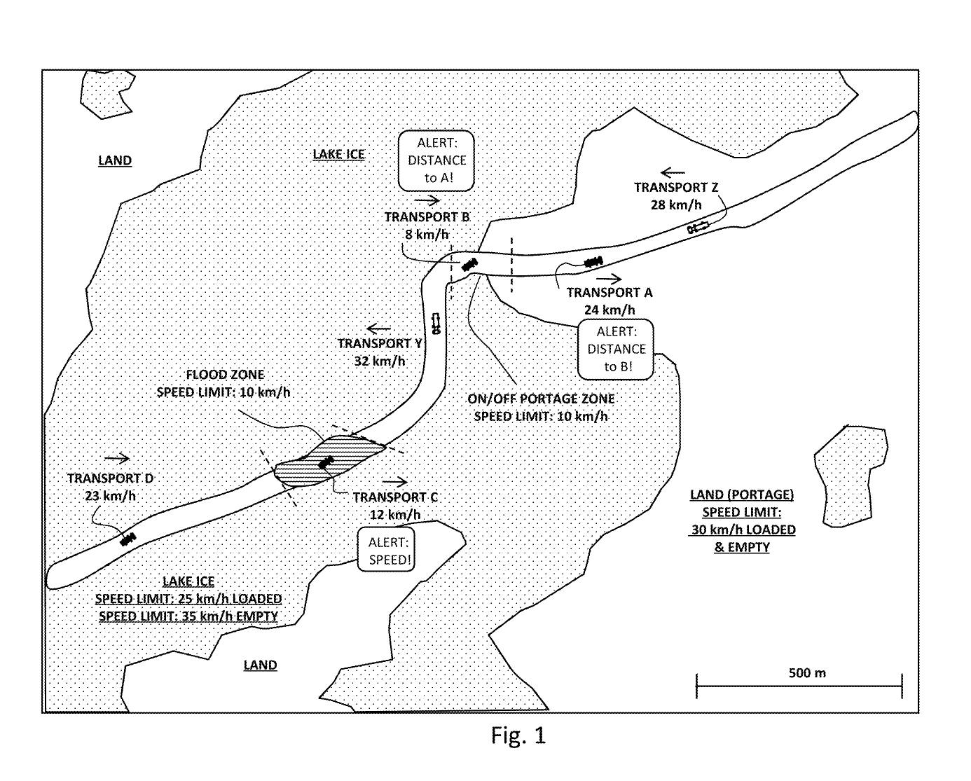

This example illustrates how the self-monitoring process operates for transport vehicles in a convoy on an ice road route. The section of the route shown in FIG. 1 has five different segments with differing speed limits as indicated in Table 2 below.

TABLE 2
Ice Road Route Speed and Distance Limits

| | Speed | Distance |
|---|---|---|
| Description of Roadway Segment and | Limit | Limit (m) |
| Transport Condition | (km/h) | (min/max) |
| Lake Surface: Loaded Vehicle | 25 | 500/1000 |
| Lake Surface: Empty Vehicle | 35 | 500/1000 |
| Portage: Loaded or Empty Vehicle | 30 | 500/1000 |
| Flood Zone on Lake | 10 | 500/1000 |
| On/Off Portage Zone | 10 | 500/1000 |

A first convoy with four vehicles shown (Transports A to D) is moving on the roadway from left to right and a second convoy with two vehicles shown (Transports Y and Z) is moving from right to left. The first convoy includes loaded transports and the second convoy includes empty transports.

Transport A is traveling on a portage zone at a speed of 24 km/h. The firmware of the network device carried by Transport A uses the positioning system to determine the location and direction of travel of Transport A in the portage zone, processes the speed of Transport A (as determined either by the satellite positioning system or by the vehicle's onboard computer system), compares the speed of Transport A with the speed limit of the portage zone and determines that Transport A is not exceeding the speed limit of 30 km/h. The network device of Transport A receives, by short range radio transmission, the location of trailing Transport B (as determined by the network device of Transport B). An automated calculation provided by the firmware indicates that Transport B is closer than 500 m to Transport A. As a result, Transport A is issued a distance alert indicating that Transport B is too close and Transport B is issued a distance alert indicating that Transport A is too close. A speed alert is not issued to Transport A because Transport A has not violated the speed limit of the portage zone. Transport A is also within 500 m of Transport Z but Transport A and Transport Z are travelling in opposite directions. The algorithm for providing distance alerts is programmed to permit opposite direction of travel and does not issue distance alerts in such cases. As such, no distance alerts are issued with respect to Transport A and Transport Z. Transport Z, traveling at 28 km/h, is not violating the portage zone speed limit of 30 km/h and does not receive a speed alert.

Transport B is traveling within an on/off portage zone at a speed limit of 8 km/h and is not exceeding the speed limit of 10 km/h. A speed alert is not issued by the network device carried by Transport B. Transport B is within 500 m of Transport Y, but Transport B and Transport Y are traveling in opposite directions and as such, no distance alerts are issued. Transport Y, traveling at a speed of 32 km/h is not violating the lake speed limit of 35 km/h for empty vehicles. In keeping with ice road construction principles, it can be seen that a dog-leg turn precedes the on/off portage zone in order to allow the wave traveling under the ice ahead of the transport vehicles to dissipate below the ice in an open portion of the lake instead of towards the portage, in order to minimize the chances of a wave breaking the ice at the on/off portage zone.

Transport C is traveling within an ice flood zone at a speed of 12 km/h and as such, is exceeding the speed limit of 10 km/h. A speed alert is issued to Transport C. The operators of the ice road route consider such speed violations to be very serious and the driver of Transport C will be issued a warning. Accumulation of a set number of such speed warnings will result in suspension of the driver.

Transport D is traveling on lake ice at a speed of 23 km/h and is not violating the speed limit of 25 km/h for loaded transports. Furthermore, it is more than 500 m away from Transport C. As such, no distance alerts are issued.

This example illustrates how the self-monitoring system operates to ensure the safety of the convoy and the prevention damage to the ice surface which could be caused by vehicles travelling at excessive speeds, particularly at portage on/off zones. Another consideration is that if successive vehicles in a convoy are too far apart, radio contact may be lost. The algorithm of the network device of each vehicle may be programmed to provide instructions to the drivers of all vehicles in the convoy to stop if one or more trailing vehicle drops outside of radio range of one or more leading vehicles. This would allow the trailing vehicle to catch up to the rest of the convoy so that radio contact can be restored in a timely manner.

### Example 2

### Self-Monitoring of Six Vehicles in a Convoy Traveling on Land

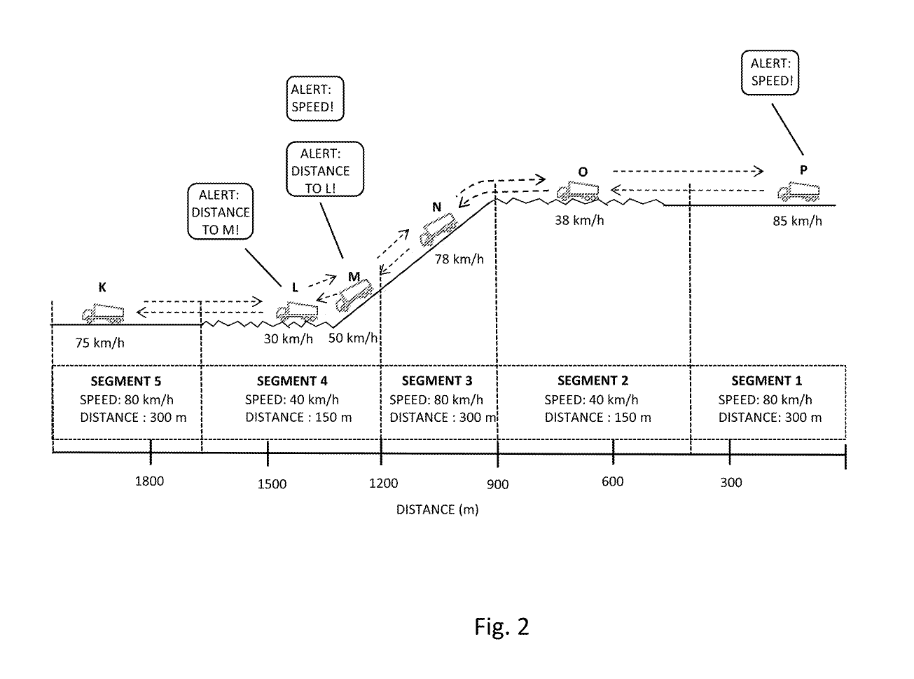

Although a number of features of the invention have been described in context of convoy vehicles traveling on an ice road, the invention may also be used for other convoy applications other than ice road transport. FIG. 2 is a diagram showing a fleet of six transport vehicles (Transports K to P) in a convoy which is spread out over five segments of a roadway on land with various topographical and surface features. The speed and distance considerations relate to potential dangers resulting from topography and surface conditions.

Segment 1, on the right side of FIG. 2 has a flat smooth surface and has been assigned a speed limit of 80 km/h and a spacing limit (distance) between vehicles of 300 m.

Segment 2, to the immediate left of Segment 1 has a flat rough surface and has been assigned a speed limit of 40 km/h and a spacing limit between vehicles of 150 m.

Segment 3, to the immediate left of Segment 2 has a steep downslope and a smooth surface and has been assigned a speed limit of 80 km/h and a spacing limit between vehicles of 300 m.

Segment 4, to the immediate left of Segment 3 has a combination of a steep smooth downslope followed by a rough surface and has been assigned a speed limit of 40 km/h and a spacing limit between vehicles of 150 m.

Segment 5, to the immediate left of Segment 4 has a flat smooth surface and has been assigned a speed limit of 80 km/h and a spacing limit between vehicles of 300 m.

In this example, Transports K to P are in a convoy (in alphabetical order) along approximately 2 km of the convoy route.

Transport K is traveling within Segment 5 at 75 km/h and is 600 m ahead of Transport L. The firmware of the network device of Transport K processes the speed of Transport K (as determined by either the satellite positioning system or by the vehicle's onboard computer system), compares the speed with the speed limit for Segment 5 in the customizable database and determines that the speed limit has not been violated. The firmware of the network device of Transport K receives the location of trailing Transport L (as determined by Transport L's satellite positioning system) via short range radio transmission. An automated calculation provided by the firmware indicates that Transport L is 600 m behind Transport K. This distance does not violate a minimum distance limit. The driver of Transport K does not receive any audible or visible speed alerts and does not receive any audible or visible distance alerts with respect to its distance from Transport L.

Transport L is traveling within Segment 4 at 30 km/h and has not violated the speed limit. As such, a speed alert is not issued by the network device of Transport L. However, the network device of Transport M receives data from Transport M indicating that Transport M is 145 m behind Transport L. The network device of Transport L issues an audible distance alert to Transport L indicating that Transport M is too close. The driver of Transport L then increases the speed of Transport L.

Transport M is traveling within Segment 4 at a speed of 50 km/h, a speed which exceeds the recommended speed limit of 40 km/h for Segment 4. As such, the network device of Transport M issues a speed alert to the driver of Transport M. In addition, Transport M receives leading vehicle data from Transport L indicating that Transport L is closer than 150 m and thus the network device of Transport M issues a distance alert to the driver of Transport M that the distance to the leading vehicle is too close. The skilled person will recognize that the total of three alerts provided to the two drivers allow both drivers to react appropriately to the situation to avoid a potential accident. The driver of Transport L may increase his speed and increase his distance from Transport M as the driver of Transport M slows down, contributing to the increase in distance of Transport M from Transport L.

Transports N and O are travelling within segments 3 (smooth downslope) and 2 (rough flat surface), respectively, and both vehicles are within the speed and distance limits for the road conditions in these segments. As such, no alerts are provided to the drivers of Transports N and O.

Finally, Transport P, traveling on the smooth flat surface of segment 1 is exceeding the speed limit and a speed alert is provided to the driver of Transport P. A distance alert is not provided to Transports O and P because the distance between Transports O and P does not violate the distance limits for segments 2 and 3.

### Example 3

### Operation of One Embodiment of the Network Device

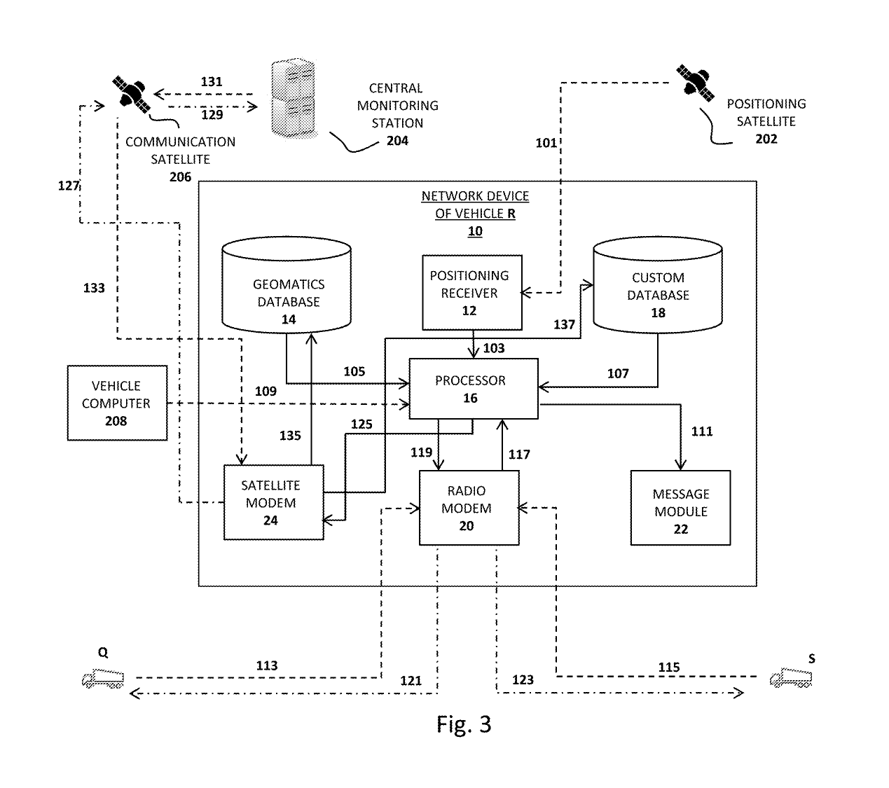

One embodiment of a network device for receiving convoy data and providing alerts to a driver of a vehicle will now be described with reference to FIG. 3 where the flow of data into the network device 10 is shown with dashed-line arrows, the flow of data within the device is shown with solid arrows and the flow of data out of the device is shown with dot-dashed arrows. This embodiment will be described with reference to an example convoy wherein each vehicle of the convoy includes a substantially similar network device having substantially similar functional capabilities. The skilled person will recognize that in such a situation, there is no “master-slave” arrangement or no “control vehicle” directing the convoy. Alerts are issued to a given vehicle based on its own speed data as well as its position data and the position data of leading and trailing vehicles. If the given vehicle is the first vehicle of the convoy, it will receive alerts based on its own speed and the position of its trailing vehicle. Likewise, if the given vehicle is the last vehicle in the convoy, it will receive alerts based on its own speed and the position of its leading vehicle. In this example, the network device 10 is shown for the second vehicle of the convoy (vehicle R). Also schematically shown in FIG. 3 are the leading vehicle (vehicle Q) with respect to vehicle B and the trailing vehicle (vehicle S) with respect to vehicle R.

The network device 10 includes seven main components which have different functions contributing to the operation of the device 10. The device includes a positioning receiver 12 for receiving positioning data from a positioning satellite 202, a geomatics database 14 for storing geomatics data including, but not limited to maps which include roads and topographical data, a processor 16 for processing data provided by the various data sources of the network, a custom database 18 which includes speed limit and distance limit data for defined segments of the convoy route, a radio modem 20 for receiving position data from leading and trailing vehicles, and for transmitting position data to the leading and trailing vehicles, a message module 22 for providing audio and/or visual alerts to the driver, and a satellite modem 24 for transmitting data to, and receiving data from, the central monitoring station 204 via a communication satellite 206. As noted above, this embodiment of the device 10 includes two databases 14 and 18. This is to facilitate a discussion of the different classes of data being transmitted to and from and within the device 10. Alternative embodiments may include only a single database that contains both geomatics data and custom data. Such databases may be programmed without undue experimentation by the skilled person and integrated with the other components of the device to provide the operations described herein.

In this example embodiment, external data is provided to the network device 10 from five different sources: the positioning satellite 202 (providing positioning data), the central monitoring station 204 (providing database updates) via a communication satellite 206, vehicle data from the computer 208 of vehicle R (which provides on-board diagnostics and other vehicle data such as speed), and position data from vehicles Q and S. The skilled person will recognize that a cellular network modem or long range radio may also be incorporated into the device to provide additional options for two-way communication with the central monitoring station 204. However, it is expected that remote convoys will be more likely to employ a satellite communication network 206.

The flow of data will now be described with reference to the arrows of FIG. 3 which are designated as “data conduits” labelled with odd-numbered reference numerals in the 100 series. Data conduits may be provided by combinations of circuits within the network device 10 and by wireless transmission by radio, a cellular network (not shown), a satellite network or a WiFi network (not shown) if available under certain situations. For example, a cellular network may be available for communication between the network device 10 and a central monitoring station 204 when the vehicle carrying the network device 10 is in an urban or suburban environment. A WiFi network may be temporarily available to the network device 10 if the vehicle is parked near a building that supports the WiFi network. In one particular example, the custom database 18 and the geomatics database 14 are both updated over a WiFi network before the vehicle drives away from the WiFi network location to join the convoy. Additional updates, if needed may then be provided over the cellular network (if available) and the satellite network.

Returning now to FIG. 3, the positioning satellite 202 provides the position data of vehicle R to the positioning receiver 12 via data conduit 101. The positioning receiver 12 is programmed to send the position data to the processor 16 via data conduit 103. The processor 16 then obtains the map data from the geomatics database 14 via data conduit 105. The processor 16 then places the position data on the map which contains the convoy route and obtains the speed limit and distance limit for the route segment containing that position, from the custom database 18 via data conduit 107. Vehicle data (for example, the speed of the vehicle) is processed by the vehicle's computer 208 is sent to the processor 16 via data conduit 109. At this stage, the processor 16 has obtained enough data relating to its own vehicle (vehicle R) to generate a message for the driver if vehicle R is violating a speed limit. In this example, the logic performed by the processor 16 would be: is vehicle R exceeding the speed limit defined for its location? If no, do nothing, if yes, transmit instructions to the message module 22 to issue an audible or visible alert message indicating that the speed limit of vehicle R is being violated. The transmission of the instructions occurs via data conduit 111. In certain embodiments, the message is also transmitted to the central monitoring station 204 (not shown).

As noted above, vehicle R′s leading and trailing vehicles (vehicles Q and S, respectively) each carry a similar network device with similar functions. As such position and speed data are known for both vehicles Q and S and these datasets are transmitted via short range radio conduits to the radio modem 20 of network device 10 of vehicle R. For vehicle Q, the transmission to the radio modem 20 occurs via data conduit 113 and for vehicle S, the transmission to the radio modem 20 occurs via data conduit 115. The speed and position data for vehicles Q and S is then conveyed to the processor 16 via data conduit 117. If, for example, data arriving at the processor from vehicle Q indicates that vehicle Q is too close to vehicle R, the logic performed by the processor 16 would be: is vehicle Q too close to vehicle R? If not, do nothing, if yes, transmit instructions to the message module 22 via data conduit 111 to issue an alert message indicating that vehicle Q is too close to vehicle R. In another example, if the data arriving at the processor from vehicle S indicates that vehicle S has reached a maximum distance threshold for radio transmissions, the logic performed by the processor would be: is vehicle S too far for reliable radio transmission? If no, do nothing, if yes, transmit instructions to all vehicles to slow down or stop to allow vehicle S to catch up to the rest of the convoy so that messages can be reliably transmitted by vehicle S.

The radio modem 20 also transmits the position and speed data to vehicles Q and S from the processor 16 to the radio modem via data conduit 119 and then via data conduits 121 and 123, respectively so that their respective network devices can issue alerts to their respective drivers if vehicle R is too close or exceeding a speed limit.

It has been noted above that both speed and position data are transmitted to leading and trailing vehicles. In alternative embodiments, it may be deemed that transmission of position data alone, to leading and trailing vehicles is sufficient to ensure the safety of the convoy and to safeguard the condition of the roadway. In such alternative embodiments, the speed limit violation alerts are only issued to the driver of the vehicle violating the speed limit.

The skilled person will understand that two convoys may overlap while travelling in opposite directions along a roadway. In such situations, the transmissions of all vehicles include direction data (heading or course over ground). This allows the algorithm of the processor to filter out data from vehicles travelling in opposite directions. This prevents the receipt of transmissions of speed and distance data at a given vehicle's network device from issuing speed and distance alerts based on data from vehicles travelling in opposite directions.

In this particular example, the network device 10 includes a means for communicating with a central monitoring station 204. It is to be understood that this is an optional feature and the network provided by the network device 10 can be limited to inclusion of the positioning satellite 202 and the data transmitted from vehicles Q and S. It is even possible to operate without connection to vehicle R′s computer (data conduit 109) if the speed data calculated on the basis of the position data by the positioning receiver is deemed sufficiently accurate.

Although optional, inclusion of a means for communication with the central monitoring station 204, (particularly two-way communication) is advantageous because it allows the central monitoring station 204 to record speed and distance violations for all networked vehicles in the convoy. A driver could then be warned or replaced if he or she is continuously violating speed and distance limits and endangering other drivers in the convoy. Additionally, the central monitoring station 204 can be appraised of the progress of the convoy in real time. Such communication from the network device 10 is shown in the data conduits 125-127-129 extending from the processor 16 to the satellite modem 24 to the communication satellite 206 and then to the central monitoring station 204.

An additional advantage to inclusion of a means for communication with the central monitoring station 204 is that the geomatics database 14b and/or the custom database 18 may be updated, for example to load new maps or to change the distance and speed limits due to adverse weather conditions. Such updates are provided with data flow from the central monitoring station 204 to the databases 14 and 18. An update of the geomatics database 14 would be transmitted via data conduits 131-133-135 and an update to the custom database 18 would be transmitted via data conduits 131-133-137.

### Equivalents and Scope

Although the present invention has been described and illustrated with respect to preferred embodiments and preferred uses thereof, it is not to be so limited since modifications and changes can be made therein which are within the full, intended scope of the invention as understood by those skilled in the art. Each reference cited herein is incorporated by reference in its entirety.

1. A method for maintaining vehicle speeds and distances between vehicles travelling in a convoy along a convoy route, the method comprising:
a) determining locations and speeds of the vehicles;
b) transmitting the locations and speeds of the vehicles by radio transmission to any of the other vehicles of the convoy within a radio communication range;
c) providing an automated speed alert to a driver of an individual vehicle of the vehicles if the speed of the individual vehicle violates a speed limit for a segment of the convoy route; and
d) providing an automated distance alert to the driver of the individual vehicle if the individual vehicle violates a distance limit for a segment of the convoy route with respect to leading and/or trailing vehicles of the fleet of vehicles.

2. The method of claim 1, wherein the radio communication is short range radio and the radio communication range is about 1 km.

3. The method of claim 1, wherein the locations and direction of travel of the vehicles are determined using a satellite positioning system.

4. The method of claim 1, wherein the speeds of the vehicles are determined using a satellite positioning system or using speed gauges of the vehicles.

5. The method of claim 1, wherein the speed limit is contained in a database of speed limits for segments of the convoy route and the vehicle's speed is automatically compared with the database of speed limits to determine compliance or violation of a speed limit for the segment of the convoy route.

6. The method of claim 1, wherein the distances of the leading and/or trailing vehicles from the vehicle are automatically compared with the database of distance limits to determine compliance or violation of a distance limit for the segment of the convoy route.

7. The method of claim 1, wherein the automated speed alert is an audible signal or a visible signal or both.

8. The method of claim 1, wherein the automated distance alert is an audible signal or a visible signal or both.

9. A device for use in an individual vehicle of a fleet of vehicles travelling along a convoy route, the device for maintaining vehicle speeds and distances between vehicles, the device comprising:
a) a satellite positioning receiver for determining the location of the individual vehicle;
b) a radio modem for transmitting the location and speed of the individual vehicle to other vehicles of the fleet of vehicles within radio transmission range and for receiving the locations and speeds of the other vehicles within radio transmission range;
c) one or more databases including:
i) map data associated with the convoy route;
ii) speed limits for defined segments of the convoy route: and
iii) vehicle distance limits for the defined segments of the convoy route; and
d) firmware configured to compare the locations and speeds of the individual vehicle and the other vehicles within radio transmission range with the speed limits and the vehicle distance limits in the databases and for providing audible and/or visible alerts if the speed limits and/or the distance limits are violated.

10. The device of claim 9, further comprising one or more additional modems for one or more corresponding communication modes selected from the group consisting of Wi-Fi network, cellular network and satellite network, the one or more communication modes for communication with a central monitoring station.

11. The device of claim 9, wherein the satellite positioning receiver is configured to receive positioning data from a GNSS system selected from a GPS system, a GLONASS system, a BeiDou system, and a Galileo system or an integrated GNSS system of any combination thereof.

12. The device of claim 9, wherein the radio modem is configured for ZigBee™ radio communication.

13. The device of claim 10, wherein the databases are configured to be updated from the central monitoring station.

14. The device of claim 9, wherein the speed of the individual vehicle is determined by an on-board vehicle computer or by a calculation performed by the satellite positioning receiver.

15. A method for maintaining vehicle speeds and distances between vehicles travelling in a convoy along a convoy route, the method comprising:
a) determining locations and speeds of the vehicles;
b) transmitting the locations and speeds of the vehicles by radio transmission to any of the other vehicles of the convoy within a radio communication range;
c) providing an automated speed alert to a driver of an individual vehicle of the vehicles if the speed of the individual vehicle violates a speed limit for a segment of the convoy route;
d) providing an automated distance alert to the driver of the individual vehicle if the individual vehicle violates a distance limit for a segment of the convoy route with respect to leading and/or trailing vehicles of the fleet of vehicles; and
e) updating the speed limit and/or the distance limit if the convoy route is subjected to changing weather and/or road surface conditions.

16. The method of claim 15, wherein step e) is performed remotely by a central monitoring station in communication with the vehicles.

17. The method of claim 16 wherein the central monitoring station communicates with the vehicles by one or more communication modes selected from the group consisting of a Wi-Fi network, a cellular network and a satellite network.

18. The method of claim 16, further comprising the step of receiving an automated weather report at the central monitoring station and automatically performing step e) on the basis of the automated weather report.

19. The method of claim 15, wherein the radio communication is short range radio and the radio communication range is about 1 km.

20. The method of claim 15, wherein the locations and direction of travel of the vehicles are determined using a satellite positioning system.

21. The method of claim 15, wherein the speeds of the vehicles are determined using a satellite positioning system or using speed gauges of the vehicles.

22. The method of claim 15, wherein the speed limit is contained in a database of speed limits for segments of the convoy route and the vehicle's speed is automatically compared with the database of speed limits to determine compliance or violation of a speed limit for the segment of the convoy route.

23. The method of claim 15, wherein the distances of the leading and/or trailing vehicles from the vehicle are automatically compared with the database of distance limits to determine compliance or violation of a distance limit for the segment of the convoy route.

24. The method of claim 15, wherein the automated speed alert is an audible signal or a visible signal or both.

25. The method of claim 15, wherein the automated distance alert is an audible signal or a visible signal or both.
